(19) United States
(12) Patent Application Publication
(10) Pub. No.: US 2006/0115738 A1
(43) Pub. Date: Jun. 1, 2006

(54) Lithium-fluorinated carbon cells

(76) Inventors: Sergiy Sazhin, Madison, WI (US); Zhihong Jin, Cottage Grove, WI (US); Terry Messing, McKinney, TX (US); Ernest Ndzebet, Madison, WI (US); Michael Root, Lino Lakes, MN (US)

Correspondence Address: SENNIGER POWERS, ONE METROPOLITAN SQUARE, 16TH FLOOR, ST. LOUIS, MO, 63102, US

(21) Appl. No.: 11/000,581

(22) Filed: Dec. 1, 2004

(51) Int. Cl. H01M 10/40; H01M 4/58; H01M 10/04

(52) U.S. Cl. 429/326; 429/231.9; 429/231.7; 429/231.95; 29/623.1

(57) ABSTRACT

An electrochemical cell has an anode that includes an alkali metal, a cathode that includes fluorinated carbon, a separator between the anode and the cathode, a non-aqueous electrolyte in electrical contact with the anode and the cathode, and at least one of an electrolyte-insoluble additive in the cathode and a electrolyte-soluble additive comprising an oxygen and a nitrogen having an oxidation level higher than +2. Methods for manufacturing and using such cells are also disclosed. The cells are adapted to be stored for extended periods of time at a wide range of high and low temperatures with maintenance of enhanced rate capability and a reduced initial voltage delay.

### CROSS-REFERENCE TO RELATED APPLICATIONS

Not Applicable

### STATEMENT REGARDING FEDERALLY SPONSORED RESEARCH OR DEVELOPMENT

Not Applicable

### BACKGROUND OF THE INVENTION

The disclosure relates to novel alkali metal-fluorinated carbon electrochemical cells having an alkali metal anode, a fluorinated carbon (CFₓ)ₙ cathode and a non-aqueous electrolyte, as well as methods for manufacturing such cells. In particular, the cathode comprises an additive that is insoluble in the electrolyte, or the electrolyte comprises an electrolyte-soluble additive, or both.

The battery industry has long desired a safe and reliable electrochemical cell or battery characterized by high rate performance, low impedance, and high flash amperage, where the cell can be stored and subsequently operated at a very wide range of temperatures. Suitable examples of such applications can be vehicle tire pressure monitors, photo batteries, and electronic field devices for military or civilian use.

A promising chemistry for such cells is lithium-fluorinated carbon [or ‘Li/(CFₓ)ₙ’], where X can range from 0.25 to 1.35, and n is least 10. Li/(CFₓ)ₙ cells can power a variety of devices under a wide range of operating conditions. The overall discharge reaction for a conventional Li/(CFₓ)ₙ cell is nxLi+(CFₓ)ₙ→nxLiF+Cₙ, where the typical anode reaction is nxLi→nxLi⁺+nxe⁻ and the typical cathode reaction is (CFₓ)ₙ+nxe⁻→Cₙ+nxF⁻.

Where x is about 1, the fluorinated carbon is referred to as poly(carbon monofluoride), or (CF)ₙ, which is a commercially available and widely used fluorinated carbon cathode material. The Li/(CF)ₙ system was one of the first commercially available lithium-solid cathode systems. On a mass basis, the (CF)ₙ cathode material has a significantly higher capacity than other commercial Li primary cell solid cathode materials and provides both performance and stability to the system.

As the practical specific energy is among the highest of all solid-cathode systems, lithium-poly(carbon monofluoride) cells are attractive for devices having low-to-medium discharge rates including computer memory and real-time clock backup, electronic counters, process controllers, portable instruments and electronic devices, time/data protection, industrial controls, electronic gas-, water-, and electric meters, communication equipment, RF tags, toll tags, and ID tags.

However, Li/(CF)ₙ cells typically exhibit an initial voltage delay or dip during discharge at constant load or during a series of pulse discharges. The voltage dip at constant load can be reduced or minimized, e.g., by partially pre-discharging, by adding C₂F or other lower fluorinated (CFₓ)ₙ material, by chemically treating, or by employing special synthetic methods. On the other hand, the voltage dip during pulse discharge has not been addressed.

The desirability of conventional Li/(CF)ₙ cells is also limited by shortcomings in storage and use at extreme temperatures. Typically, Li/(CF)ₙ electrochemical cells are stored and can operate at temperatures from −30° C. to +80° C. However, cell performance deteriorates after storage at temperatures above 80° C. or after extended use at temperatures at or above 100° C. Use of conventional Li/(CF)ₙ cells in higher temperature applications is typically limited by physical and chemical properties of materials used in the cell. In particular, under conditions of high thermal stress, e.g., at or above 125° C., polypropylene grommets in cell seals tend to flow or oxidize and can detrimentally affect the electrical and physical characteristics of the cell. Also, standard non-woven polypropylene, which serves as a mechanical cushion and an insulator between the anode and cathode, tends to shrink and begins to melt. Still further, dimethoxy ethane (DME), a highly volatile component provided in the electrolyte along with lithium tetrafluoroborate (LiBF₄) salt and propylene carbonate (PC), can diffuse around and through the seal under these conditions, causing an increase in cell impedance and electrical degradation.

It is therefore desired to modify the chemistry of conventional Li/(CF)ₙ cells having a grommet seal, polypropylene separator and LiBF₄-PC-DME electrolyte for storage and operation at temperatures between about 80° C. and about 125° C. to reduce or eliminate positive current collector corrosion and to employ compatible materials in the cell. Unfortunately, prior attempts to increase performance by modifying the cathode and the electrolyte in the basic lithium cell have shown little success. For example, prior efforts employed additives to the CFx cathode, such as silver vanadium oxide, copper-silver-vanadium oxide, manganese dioxide, lithium cobalt oxide, lithium nickel oxide, copper oxide, titanium disulfide, copper sulfide, iron sulfide, iron disulfide, copper vanadium oxide, and mixtures thereof. However, these prior efforts did not address pulse performance, storage conditions at elevated temperatures, or low temperature performance.

Others have attempted to improve performance of a different lithium-containing cell chemistry (Li/MnO₂) by providing additives in the MnO₂ cathodes. For example, one prior effort used alkaline earth metal salts to suppress the build-up of internal impedance during storage and to improve pulse discharge characteristics even after prolonged storage. The cells were stored at a maximum of 60° C. and after that were discharged above −20° C. Indeed, it was there proposed that acid groups on the MnO₂ react with the salts, thereby improving cathode performance. However, (CFₓ)ₙ cathode has no such acid groups to react with the lithium salts, therefore such salts would not be expected to improve (CFₓ)ₙ cathode performance.

The non-aqueous electrolyte has also been modified in Li/MnO₂ cells with little success. For example, others have disclosed a Li/MnO₂ cell having a non-aqueous electrolyte containing a LiCF₃SO₃ solute and a LiNO₃ , triethyl phosphate or tri-n-butyl phosphate additive suppressing corrosion of the cell cans, thereby preventing lowering of the post-storage low temperature discharge characteristics. However, the cells were stored at a maximum of 60° C. and after that were discharged above −20° C.

Another effort described preventing reduction in high rate discharge (at room temperature after storage at 60° C.) of electrochemical cells having a lithium anode and MnO₂ cathode with non-aqueous PC-DME solvent mixture and LiPF₆ solute by providing a reaction inhibitor additive selected from LiNO₃ , N N N′N′-tetra methyl ethylene diamine, 1,2 diphenyl ethylene diamine, diethyl dithio sodium carbamate, phosphite tri ethyl, phosphite tri-n-butyl, tri ethyl phosphate, ammonium phosphate, ammonium hypophosphate, and orthophosphate urea. The additive suppressed corrosion of the positive current collector.

As noted, these efforts relate to Li/MnO₂ not Li/(CF)ₙ cells. However, they do not teach a solution for improving either Li/MnO₂ or Li/(CF)ₙ cell performance at ′40° C., at either a continuous constant load- or a pulse mode discharge and do not teach a solution for reducing the impedance during storage at 110° C. of either Li/MnO₂ or Li/(CF)ₙ cells.

In summary, previous efforts have not improved the range of suitable storage conditions or low temperature performance after elevated temperature storage of Li/(CFₓ)ₙ cells. It would be desirable to produce a lithium-fluorinated carbon Li/(CFₓ)ₙ, in particular, a Li/(CF)ₙ cell, capable of low temperature pulse performance and increased storage capability at the same time.

### BRIEF SUMMARY OF THE INVENTION

Various advantages are achieved by a cell, such as a cylindrical wound, prismatic wound, flat flexible or a thin coin cell, having an anode that includes an alkali metal, a cathode that includes fluorinated carbon, a separator between the anode and the cathode, a non-aqueous electrolyte in electrical contact with the anode and the cathode, and at least one agent selected from (a) an electrolyte-insoluble, rechargeable additive in the cathode having an oxidation-reduction potential close to the operating potential of a (CFₓ)ₙ cathode and a rate capability higher than that of (CFₓ)ₙ, (b) an electrolyte-soluble additive comprising an oxygen and a nitrogen having an oxidation level higher than +2, and (c) an additive that reacts in the cell to form a compound having the recited attributes of additive (a), the agent being provided in the cell in an amount effective to achieve a stated object. The separator is desirably chemically inert and thermally stable in use.

In one embodiment, the electrolyte-insoluble additive includes an inorganic material.

In a related embodiment, the electrolyte-insoluble additive includes an inorganic salt having a general formula AₓM_{y}O_{z} where A is a metal from Group IA or IB of the Periodic Table of Elements, M is a transition metal or an element from Group IIIA, IVA, VA or VIA of the Periodic Table, and x, y, and z are integers chosen to balance the charge of the compound, as will be understood by the skilled artisan.

In one embodiment, the salt includes a lithium salt.

In another embodiment, the salt includes a transition metal oxide.

In still another embodiment, the cathode additive includes a conductive organic molecule.

In yet another embodiment, the conductive organic molecule is polyaniline.

In still another embodiment, the electrolyte-soluble additive is LiNO₃.

In another aspect a Li/(CF)ₙ cell containing at least one of the additives exhibits a reduced initial voltage delay under continuous discharge on constant load- and pulse mode discharge.

Unless otherwise defined, all technical and scientific terms used herein have the same meaning as commonly understood by one of ordinary skill in the art. Although suitable methods and materials for practice or testing are described below, other methods and materials similar or equivalent to those described herein, which are well known in the art, can also be used.

Other aspects, advantages and features will become apparent from the following specification taken in conjunction with the accompanying drawings.

### BRIEF DESCRIPTION OF THE SEVERAL VIEWS OF THE DRAWINGS

FIG. 1 compares 10 mA pulse test performance at −40° C. (low temperature) for control BR2335R cells containing electrolyte lacking LiNO₃ and test cells containing electrolyte with different concentrations of LiNO₃ additive. The cells were pulsed for 100 milliseconds every 15 seconds. The cells were not subjected to high temperature storage before testing.

FIG. 2 compares the impedance rise during storage at 110° C. of the control and test BR2335R cells.

FIG. 3 compares 10 mA pulse test performance at −40° C. (low temperature) for control BR2335R cells containing electrolyte lacking LiNO₃ and test cells containing electrolyte with 0.05M LiNO₃ additive. The cells were pulsed for 100 milliseconds every 15 seconds. The cells were subjected to high temperature storage for 1 hour at 110° C. followed by 24 hours of rest at room temperature and cool down to −40° C. for 4 hours before testing.

FIG. 4 compares 10 mA pulse test performance at −40° C. (low temperature) for control BR2335R cells containing electrolyte lacking LiNO₃ and test cells containing electrolyte with 0.05M LiNO₃ additive. The cells were pulsed for 100 milliseconds every 15 seconds. The cells were subjected to high temperature storage for 1 hour at 125° C. followed by 24 hours of rest at room temperature and cool down to −40° C. for 4 hours before testing.

FIG. 5 compares 0.5 mA pulse test performance at −40° C. (low temperature) for control BR1225R cells containing electrolyte lacking LiNO₃ and test cells containing electrolyte with 0.1 M LiNO₃ additive. The cells were pulsed for 100 milliseconds every minute. The cells were not subjected to high temperature storage.

FIG. 6 compares 0.5 mA pulse test performance at −40° C. (low temperature) for control BR1225R cells containing electrolyte lacking LiNO₃ and test cells containing electrolyte with 0.1M LiNO₃ additive. The cells were pulsed for 100 milliseconds every minute. The cells were subjected to high temperature storage for 1 hour at 110° C. followed by 24 hours of rest at room temperature and cool down to −40° C. for 4 hours before testing.

### DETAILED DESCRIPTION OF THE INVENTION

The disclosure relates to a lithium-fluorinated (Li/(CFₓ)ₙ) carbon electrochemical cell, especially a Li/(CF)ₙ cell, comprising in the cathode a rechargeable cathode active material (depolarizer) that is more conductive in use than, and has a higher rate of electrochemical reaction than, (CFₓ)ₙ. Enhanced cell performance is attributable to inclusion of the additives in amounts effective to enhance performance. Specifically, the additives improve cell performance relative to comparable cells lacking the additives, with respect to Li/(CF)ₙ cell rate capability, including reduction of initial voltage delay at constant load or during pulse discharges.

Without being held to any specific theory, it is believed that during a pulse discharge cycle having a pulse stage and a rest stage, the cathode additive(s), or one or more product produced from the additive provided in the cell, take on a current load during the pulse stage and recover from the (CFₓ)ₙ (i.e., regenerate) during the rest stage. During the pulse stage, the additive or the product is more preferentially reduced than (CFₓ)ₙ. During the rest stage, the reduced additive or the product is oxidized by bulk (CFₓ)ₙ and is thereby engaged for the next pulse. The particular mechanism can vary with the oxidation level of the additive. For example, if an additive would reduce (CFₓ)ₙ, the additive would be oxidized during cell manufacture when the electrolyte contacts the cathode. The oxidized product produced in the cell, rather than the additive, would then be available to act as described during the next pulse.

Any additive that supports this ‘regeneration’ concept, can be used to improve the pulse performance. A suitable cathode additive material can be an inorganic, electrolyte-insoluble, rechargeable additive having an oxidation-reduction potential close to the operating potential of a (CFₓ)ₙ, cathode (2-3.5 V +/−200 mV vs. lithium electrode) and a rate capability in the cell higher than that of (CFₓ)ₙ. The cathode additive can be provided in an amount of up to about 20% by weight of the weight of (CFₓ)ₙ in the cathode.

The cathode additive can be an inorganic material, such as a salt having a general formula AₓM_{y}O_{z} where A is a metal from Group IA or IB of the Periodic Table of Elements, M is a transition metal or an element from Group IIIA, IVA, VA or VIA of the Periodic Table, and x, y, and z are integers chosen to balance the charge of the compound. In particular, the metal A can be lithium and the additive can include a transition metal oxide. Suitable inorganic cathode additives can include but are not limited to lithium titanium oxide, lithium silicate, lithium vanadium oxide, lithium zirconium oxide, lithium niobium oxide, lithium tungsten oxide, lithium molybdenum oxide, lithium tantalum oxide, lithium manganese oxide, lithium cobalt oxide, lithium sulfate, lithium borate, lithium phosphate and lithium aluminum oxide, and mixtures thereof.

It is also contemplated that rechargeable cathode materials from other classes, including organic materials having an oxidation-reduction potential close to the operating potential of (CFₓ)ₙ in the cathode, can also be used for this purpose. One such example is polyaniline, a stable conducting polymer having excellent electrochemical reversibility.

Alternatively or additionally, the Li/(CFₓ)ₙ, cells can comprise in the electrolyte an electrolyte-soluble additive that enhances the above-noted cathode-related properties by inhibiting corrosion of at least one of the lithium anode and the positive current collector, thereby improving cell storage capability at a temperature up to about 125° C. and improving pulse performance at −40° C. after storage at up to about 125° C.

A suitable electrolyte-soluble additive has an oxygen and a nitrogen having an oxidation level higher than +2 and is compatible with the salt and solvent components of the electrolyte and with the anode and cathode, as well as with any discharge reaction products. Suitable additives can include lithium nitrate and lithium nitrite. The electrolyte-soluble additive can be provided in the electrolyte at a concentration range of between about 0.02 to about 0.2 M, or between about 0.025 and about 0.10 M, or about 0.05 M.

In the cell, the electrolyte-soluble additive reacts with the positive current collector to deposit an insoluble metal oxide layer on the surface thereof. The metal oxide layer protects the positive current collector from corrosion better than the metal halide-containing layers that form on the positive current collector of conventional (CFₓ)ₙ cells in the presence of halide anions such as F⁻. The metal oxide layer also increases conductivity at the cathode-current collector interface, thereby reducing impedance and enabling high-rate performance. Still further, the electrolyte-soluble additive can also improve properties of the lithium anode by forming on the surface thereof a modified solid electrolyte interface (SEI) layer having a higher Li-ion conductivity than an SEI formed in the absence of the additive. The SEI layer protects the lithium from attack by the electrolyte or by impurities such as products produced by corrosion of the cathode current collector. This enhanced protection can result in a lesser increase in impedance during high-temperature cell storage than is observed in conventional (CFₓ)ₙ cells.

The chemical reactions for a lithium nitrate additive in a (CFₓ)ₙ cell are shown below in Table 1. A mixture of Li₂O and Li₃N, produced in the second and third reactions shown below, forms an SEI on the lithium anode and is a desirable solid electrolyte characterized by a high Li-ion conductivity level.

TABLE 1

| Reactions with a cathode current collector, | |
|---|---|
| where Me is the metal(s) of a current collector: | |
| yLiNO₃ + xMe → yLiNO₂ + MeₓO_{y} | (1) |
| Additive reaction with lithium anode | |
| LiNO₃ + 8Li → 3Li₂O + Li₃N | (2) |
| Additive product reaction with lithium anode | |
| LiNO₂ + 6Li → 2Li₂O + Li₃N | (3) |

The improvements can be practiced in conjunction with other known aspects of cell design including, for example, providing on the cathode current collector a primer coating that comprises carbons and binders. The primer increases adhesion of the cathode active mass to the current collector and improves current distribution at high rates, resulting in higher capacity and rate capability. Also, when employed in a wound cell, the electrodes can be as thin as about 0.1-0.2 mm and as long as 1-6 feet (depending upon the size of the cell) to increase capacity utilization and high rate capability of the cells. Furthermore, other conducting agents in the cathode mixture (i.e., a matrix comprising several varieties of carbons having various shapes and sizes, which can include carbon fibers) may be used in conjunction with the described additives to achieve the objectives described herein.

The following examples, which are not intended to limit the scope of the invention, show suitable materials and methods that can be used to produce electrochemical cells in accord with the disclosure.

### EXAMPLES

### Example 1

A high-rate Li/(CF)n cell having additional insoluble active materials in the cathode, relative to conventional cells, was constructed to determine the effects of the additives on high-rate pulse capability and initial voltage delay.

In this embodiment, Li/(CF)n cells having a cathode layer thickness of less than 125 μm were produced by depositing a thin layer (5-15 μm) of a primer mixture containing conductive carbons and binders on one side of a thin aluminum foil (25 μm). A cathode active mass was then coated on the deposited primer layer using a reverse-roll coating method to produce a cathode strip having a thickness in the range of 84-147 μm. By weight, the cathode active mass for control cells included 79% (CF)ₙ, 10% conductive carbon including carbon fibers, graphite and carbon black, and 11% binder. In test cells, a lithium salt additive (as in Table 2) replaced 20% (by weight) of the (CF)n of the control cathode. Accordingly, cathode formulations for test cells having a cathode additive contained 63% (CF)n and 16% additive, by weight.

Coin cells were produced in 2016 (20 mm diameter, 1.6mm thick) coin cell hardware. Cathode discs were punched from the cathode strip and were welded using a resistance welder with a bare side to the 2016 can. Remaining cell components were placed in the 2016 coin cell vehicle. Lithium anode thickness for this modified 2016 coin cell was increased from standard 0.24 mm to 0.81 mm to compensate for the decrease in cathode thickness from standard thickness and to reduce the distance between electrodes. Cells were activated with a non-aqueous electrolyte solution of IM LiBF₄ in PC:DME (50:50).

The cells thus assembled were tested to evaluate the impact of the selected cathode additives. Cells were pre-discharged at 3.7 mA for 24 minutes, during which initial voltage dip was monitored. The cells were then kept at room temperature for one day and were then repeatedly pulsed with a 6.67 mA discharge current for 3 seconds followed by a 7 second rest. The lowest voltage recorded was noted during the initial 100 pulses.

Table 2 compares the lowest pulse voltage and the initial voltage dip at constant load discharge for cells having control and test cathodes, as described.

TABLE 2

| | | Pulse voltage | | Initial voltage dip | |
|---|---|---|---|---|---|
| | Cathode | Lowest | Advantage vs | Lowest | Advantage vs |
| # | composition | voltage, V | control, V | voltage, V | control, V |
| 1 | Control, (CF)n | 2.256 ± 0.011 | 0 | 2.136 ± 0.031 | 0 |
| 2 | (CF)ₙ + Li₂TiO₃ | 2.292 ± 0.006 | 0.036 | 2.117 ± 0.015 | −0.019 |
| 3 | (CF)ₙ + Li₂SiO₃ | 2.285 ± 0.023 | 0.030 | 2.084 ± 0.084 | −0.052 |
| 4 | (CF)ₙ + LiVO₃ | 2.296 ± 0.012 | 0.040 | 2.119 ± 0.067 | −0.017 |
| 5 | (CF)ₙ + Li₂ZrO₃ | 2.293 ± 0.012 | 0.046 | 2.176 ± 0.049 | 0.071 |
| 6 | (CF)ₙ + LiNbO₃ | 2.278 ± 0.010 | 0.031 | 2.121 ± 0.044 | 0.017 |

Each lithium salt tested (including lithium titanium oxide, lithium silicate, lithium vanadium oxide, lithium zirconium oxide, and lithium niobium oxide) improved the pulse performance, increasing the voltage under pulse by 30-46 mV, on average. Lithium zirconium oxide and lithium niobium oxide, also partially eliminate the initial voltage dip during constant current predischarge, increasing voltage by 17-71 mV, on average. Other additives that decrease initial voltage dip in Li/CFx cells include lithium tungsten oxide and lithium molybdenum oxide. In particular, a (CF)ₙ cathode containing 5% of either Li₂WO₄ or Li₂MoO₄ exhibits a higher discharge voltage and less voltage dip at constant load continuous discharge.

### Example 2

In another embodiment, coin cells of 2335 design (23 mm diameter, 3.5 mm thick) were constructed. Each cell contained 85.6 mg of lithium as the anode, 470 mg of a cathode pellet containing 85.5 weight percent (CF)ₙ, 9.5 weight percent acetylene black, 5 weight percent binder, and about 520 mg of an electrolyte. A carbon primer (paint) was applied to cathode current collector in order to improve electrical contact between current collector and the cathode pellet. Two layers of non-woven polypropylene separator were used. One group of cells was filled with standard electrolyte, 1 M solution of LiBF₄ in PC-DME (1:1). Another group of cells re filled with electrolyte comprising varying amount of LiNO₃ additive.

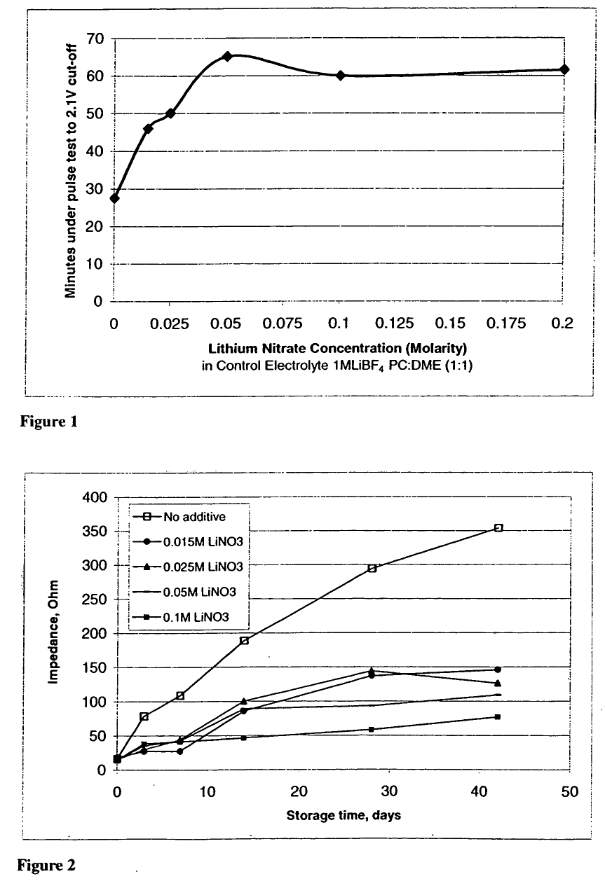

FIG. 1 depicts comparative results of low-temperature pulse discharge tests. The cells did not undergo high temperature storage. Maximum efficiency under tested conditions was reached when the electrolyte contained 0.05M LiNO₃. At this concentration, the average duration in minutes under pulse to 2.1V cut-off was 2.37 times longer than for cells containing control electrolyte. It is observed that 0.05M LiNO₃ additive concentration is 3.6 times higher than maximal preferred additive concentration of 0.015 M (or 1 g/L) disclosed in the current literature.

### Example 3

In another embodiment, impedance of BR2335R cells constructed as described in Example 2 was measured during storage at 110° C. Impedance at 1000 Hz was measured at room temperature after the cells were cooled down for 2 hours from 110° C. FIG. 2 shows the impedance rise during cell storage. FIG. 2 also demonstrates that the presence of LiNO₃ significantly inhibits cell impedance rise during storage for at least 42 days. This inhibition directly translates to better storage performance, longer shelf life, and higher rate capability in the test cells. Lowest impedance was observed for cells containing 0.1 M LiNO₃ additive in the electrolyte. This concentration is 7.1 times higher than the maximal preferred concentration of 0.0 1 5M (or 1 g/L) in the current literature.

### Example 4

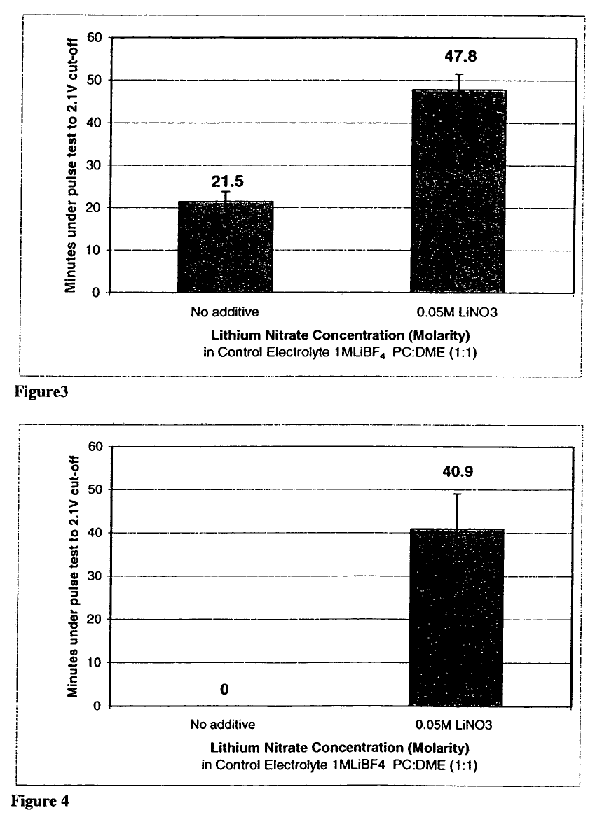

In another embodiment, the pulse performance of BR2335R cells generally constructed as described in Example 2 was measured at −40° C. after storage for 1 hour at 110° C. and rest for 24 hours at room temperature and cool down to −40° C. for 4 hours. The cells were pulsed for 100 milliseconds every 15 seconds. FIG. 3 shows that the time under pulse test to 2.1 V cutoff was 2.2 times as long for cells comprising 0.05 M LiNO₃ in the electrolyte than for control cells lacking LiNO₃ in the electrolyte. FIG. 4 depicts the effect of storage at a still higher temperature than was tested in FIG. 3. In FIG. 4, the control and test cells were tested after handling at conditions identical to those of FIG. 3 except that the cells were stored for one hour at 125° C. Cells containing 0.05M LiNO₃ retained 63% of their initial (FIG. 1) capability, while the cells containing the control electrolyte did not perform, demonstrating the measurable performance advantage of a Li/(CF)ₙ cell containing an electrolyte supplemented with an additive in accord with the disclosure.

### Example 5

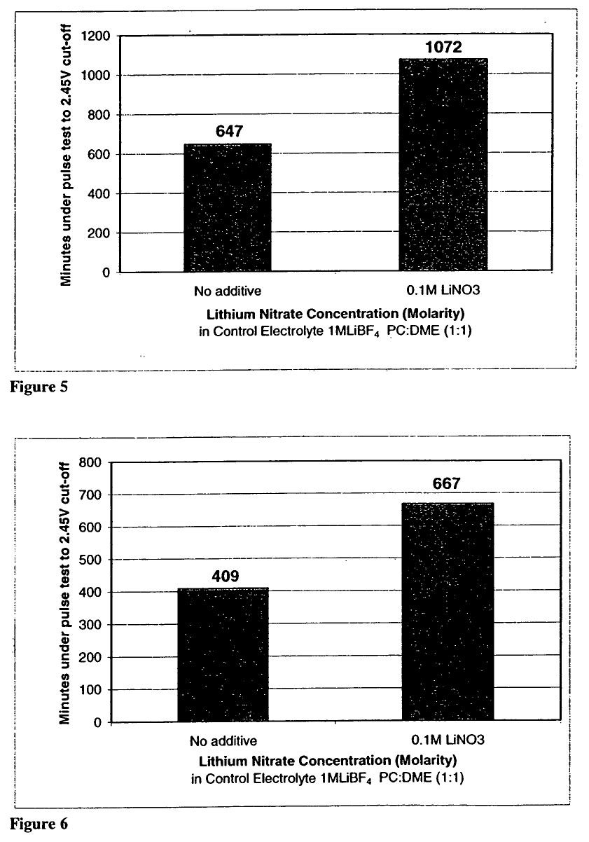

In another embodiment, Li/(CF)ₙ coin cells of 1225 design (12 mm diameter, 2.5 mm thick) were constructed. The 1225 design is similar to the 2335 design of Example 2, but differs in dimension and material loading. Each cell contained 14.4 mg of lithium as the anode, 82 mg of a cathode mix, and about 82 mg of an electrolyte, either control electrolyte [1 M solution of LiBF₄ in PC-DME (1:1)], or the control electrolyte plus 0.1 M LiNO₃. Cells were either stored for 24 hours at 110° C. or not, and then were pulse tested (0.5 mA for 100 milliseconds every minute) at −40° C. Time under pulse test to 2.45 V cutoff was determined for each kind of cell. FIGS. 5 and 6 show the pulse performance of the cells without and with high temperature storage, respectively. In each case, cells containing LiNO₃ in the electrolyte outperformed the cells containing control electrolyte by 1.6 times.

Although the foregoing has been described in some detail by way of illustration and example for purposes of clarity of understanding, it will be readily apparent to those of ordinary skill in the art that certain changes and modifications may be made thereto without departing from the spirit or scope of the appended claims.

We claim:

1. An electrochemical cell comprising an anode that includes an alkali metal, a cathode that includes a fluorinated carbon, a separator between the anode and the cathode, a non-aqueous electrolyte in electrical contact with the anode and the cathode, and at least one agent selected from the group consisting of (a) an electrolyte-insoluble, rechargeable additive in the cathode having an oxidation-reduction potential close to the operating potential of a (CFₓ)ₙ cathode and a rate capability higher than that of (CFₓ)ₙ, (b) an electrolyte-soluble additive comprising an oxygen and a nitrogen having an oxidation level higher than +2, and (c) an additive that reacts in the cell to form a compound having the recited attributes of additive (a), the at least one agent being added in an amount effective to effect a performance improvement relative to a lithium-fluorinated carbon cell lacking the additive, the performance improvement being selected from the group consisting of improved storage capability at a storage temperature up to about 125° C., increased rate capability in a pulse test at −40° C. after storage at a temperature up to about 125° C., and reduced initial voltage delay under continuous discharge on constant load and pulse mode discharge.

2. The cell of claim 1 wherein the fluorinated carbon is poly(carbon monofluoride).

3. The cell of claim 1 wherein the alkali metal is lithium.

4. The cell of claim 1 wherein the electrolyte-insoluble additive comprises an inorganic material.

5. The cell of claim 1 wherein the electrolyte-insoluble additive comprises an inorganic salt having a general formula AₓM_{y}O_{z}, where A is a metal from Group IA or IB of the Periodic Table of Elements, M is a transition metal or an element from Group IIIA, IVA, VA or VIA of the Periodic Table, and x, y, and z are integers chosen to balance the charge of the compound.

6. The cell of claim 1 wherein the electrolyte-insoluble additive comprises a lithium salt.

7. The cell of claim 1 wherein the electrolyte-insoluble additive comprises a transition metal oxide.

8. The cell of claim 1 wherein the electrolyte-insoluble additive is selected from the group consisting of lithium titanium oxide, lithium vanadium oxide, lithium zirconium oxide, lithium niobium oxide, lithium tungsten oxide, lithium molybdenum oxide, lithium tantalum oxide, lithium manganese oxide, lithium cobalt oxide, lithium silicate, lithium sulfate, lithium borate, lithium phosphate, lithium aluminum oxide, and a mixture of any of the foregoing.

9. The cell of claim 1 wherein the electrolyte-insoluble additive comprises an organic material.

10. The cell of claim 9 wherein the organic material comprises polyaniline.

11. The cell of claim 1 wherein the electrolyte-soluble additive is selected from the group consisting of lithium nitrate and lithium nitrite.

12. An electrochemical cell comprising an anode that includes lithium, a cathode that includes poly(carbon monofluoride), a separator between the anode and the cathode, a non-aqueous electrolyte in electrical contact with the anode and the cathode, and at least one agent selected from the group consisting of (a) an electrolyte-insoluble, rechargeable additive in the cathode having an oxidation-reduction potential close to the operating potential of a (CFₓ)ₙ cathode and a rate capability higher than that of (CFₓ)ₙ, (b) an electrolyte-soluble additive comprising an oxygen and a nitrogen having an oxidation level higher than +2, and (c) an additive that reacts in the cell to form a compound having the recited attributes of additive (a), the at least one agent being added in an amount effective to effect a performance improvement relative to a lithium-fluorinated carbon cell lacking the additive, the performance improvement being selected from the group consisting of improved storage capability at a storage temperature up to about 125° C., increased rate capability in a pulse test at −40° C. after storage at a temperature up to about 125° C., and reduced initial voltage delay under continuous discharge on constant load and pulse mode discharge.

13. The cell of claim 12 wherein the electrolyte-insoluble additive comprises an inorganic material.

14. The cell of claim 12 wherein the electrolyte-insoluble additive comprises an inorganic salt having a general formula AₓM_{y}O_{z}, where A is a metal from Group IA or IB of the Periodic Table of Elements, M is a transition metal or an element from Group IIIA, IVA, VA or VIA of the Periodic Table, and x, y, and z are integers chosen to balance the charge of the compound.

15. The cell of claim 12 wherein the electrolyte-insoluble additive comprises a lithium salt.

16. The cell of claim 12 wherein the electrolyte-insoluble additive comprises a transition metal oxide.

17. The cell of claim 12 wherein the electrolyte-insoluble additive is selected from the group consisting of lithium titanium oxide, lithium vanadium oxide, lithium zirconium oxide, lithium niobium oxide, lithium tungsten oxide, lithium molybdenum oxide, lithium tantalum oxide, lithium manganese oxide, lithium cobalt oxide, lithium silicate, lithium sulfate, lithium borate, lithium phosphate, lithium aluminum oxide, and a mixture of any of the foregoing.

18. The cell of claim 12 wherein the electrolyte-insoluble additive comprises an organic material.

19. The cell of claim 18 wherein the organic material comprises polyaniline.

20. The cell of claim 12 wherein the electrolyte-soluble additive is selected from the group consisting of lithium nitrate and lithium nitrite.

21. A method of making an electrochemical cell having an anode having an alkali metal, a cathode having a fluorinated carbon, a separator located between the anode and the cathode, and a non-aqueous electrolyte, the method comprising:
providing in the cathode an electrolyte-insoluble, rechargeable additive having an oxidation-reduction potential close to the operating potential of a (CFₓ)ₙ cathode and a rate capability higher than that of (CFₓ)ₙ, the additive being added in an amount effective to effect a performance improvement relative to an alkali metal-fluorinated carbon cell lacking the additive, the performance improvement being selected from the group consisting of improved storage capability at a storage temperature up to about 125° C., increased rate capability in a pulse test at −40° C. after storage at a temperature up to about 125° C., and reduced initial voltage delay under continuous discharge on constant load and pulse mode discharge.

22. The method of claim 21 wherein the fluorinated carbon is poly(carbon monofluoride).

23. The method of claim 21 wherein the alkali metal is lithium.

24. The method of claim 21 wherein the electrolyte-insoluble additive comprises an inorganic material.

25. The method of claim 21 wherein the electrolyte-insoluble additive comprises an inorganic salt having a general formula AₓM_{y}O_{z}, where A is a metal from Group IA or IB of the Periodic Table of Elements, M is a transition metal or an element from Group IIIA, IVA, VA or VIA of the Periodic Table, and x, y, and z are integers chosen to balance the charge of the compound.

26. The method of claim 21 wherein the electrolyte-insoluble additive comprises a lithium salt.

27. The method of claim 21 wherein the electrolyte-insoluble additive comprises a transition metal oxide.

28. The method of claim 21 wherein the electrolyte-insoluble additive is selected from the group consisting of lithium titanium oxide, lithium vanadium oxide, lithium zirconium oxide, lithium niobium oxide, lithium tungsten oxide, lithium molybdenum oxide, lithium tantalum oxide, lithium manganese oxide, lithium cobalt oxide, lithium silicate, lithium sulfate, lithium borate, lithium phosphate, lithium aluminum oxide, and a mixture of any of the foregoing.

29. The method of claim 21 wherein the electrolyte-insoluble additive comprises an organic material.

30. The method of claim 29 wherein the organic material comprises polyaniline.

31. The method of claim 21 further comprising:
providing an electrolyte-soluble additive in the non-aqueous electrolyte, the additive comprising an oxygen and a nitrogen having an oxidation level higher than +2, at least one of the additives being added in an amount effective to effect a performance improvement relative to an alkali metal-fluorinated carbon cell lacking the additive, the performance improvement being selected from the group consisting of improved storage capability at a storage temperature up to about 125° C., increased rate capability in a pulse test at −40° C. after storage at a temperature up to about 125° C., and reduced initial voltage delay under continuous discharge on constant load and pulse mode discharge.

32. The method of claim 31 wherein the electrolyte-soluble additive is selected from the group consisting of lithium nitrate and lithium nitrite.

33. A method of making an electrochemical cell having an anode having an alkali metal, a cathode having a fluorinated carbon, a separator located between the anode and the cathode, and a non-aqueous electrolyte, the method comprising:
providing an electrolyte-soluble additive in the non-aqueous electrolyte, the additive comprising an oxygen and a nitrogen having an oxidation level higher than +2,
the additive being added in an amount effective to effect a performance improvement relative to an alkali metal-fluorinated carbon cell lacking the additive, the performance improvement being selected from the group consisting of improved storage capability at a storage temperature up to about 125° C., increased rate capability in a pulse test at −40° C. after storage at a temperature up to about 125° C., and reduced initial voltage delay under continuous discharge on constant load and pulse mode discharge.

34. The method of claim 33 wherein the electrolyte-soluble additive is selected from the group consisting of lithium nitrate and lithium nitrite.

35. The method of claim 33 further comprising:
providing in the cathode an electrolyte-insoluble, rechargeable additive having an oxidation-reduction potential close to the operating potential of a (CFₓ)ₙ cathode and a rate capability higher than that of (CFₓ)ₙ, at least one of the additives being added in an amount effective to effect a performance improvement relative to a alkali metal-fluorinated carbon cell lacking the additive, the performance improvement being selected from the group consisting of improved storage capability at a storage temperature up to about 125° C., increased rate capability in a pulse test at −40° C. after storage at a temperature up to about 125° C., and reduced initial voltage delay under continuous discharge on constant load and pulse mode discharge.

36. The method of claim 35 wherein the electrolyte-insoluble additive comprises an inorganic material.

37. The method of claim 35 wherein the electrolyte-insoluble additive comprises an inorganic salt having a general formula AₓM_{y}O_{z}, where A is a metal from Group IA or IB of the Periodic Table of Elements, M is a transition metal or an element from Group IIIA, IVA, VA or VIA of the Periodic Table, and x, y, and z are integers chosen to balance the charge of the compound.

38. The method of claim 35 wherein the electrolyte-insoluble additive comprises a lithium salt.

39. The method of claim 35 wherein the electrolyte-insoluble additive comprises a transition metal oxide.

40. The method of claim 35 wherein the electrolyte-insoluble additive is selected from the group consisting of lithium titanium oxide, lithium vanadium oxide, lithium zirconium oxide, lithium niobium oxide, lithium tungsten oxide, lithium molybdenum oxide, lithium tantalum oxide, lithium manganese oxide, lithium cobalt oxide, lithium silicate, lithium sulfate, lithium borate, lithium phosphate, lithium aluminum oxide, and a mixture of any of the foregoing.

41. The method of claim 35 wherein the electrolyte-insoluble additive comprises an organic material.

42. The method of claim 41 wherein the organic material comprises polyaniline.

43. A method of making an electrochemical cell having an anode having an alkali metal, a cathode having a fluorinated carbon, a separator located between the anode and the cathode, and a non-aqueous electrolyte, the method comprising:
providing in the cathode an additive that reacts in the cell to form an electrolyte-insoluble, rechargeable additive having an oxidation-reduction potential close to the operating potential of a (CFₓ)ₙ cathode and a rate capability higher than that of (CFₓ)ₙ, the reactive additive being added in an amount effective to effect a performance improvement relative to a lithium-fluorinated carbon cell lacking the additive, the performance improvement being selected from the group consisting of improved storage capability at a storage temperature up to about 125° C., increased rate capability in a pulse test at −40° C. after storage at a temperature up to about 125° C., and reduced initial voltage delay under continuous discharge on constant load and pulse mode discharge.

44. The method of claim 43 wherein the fluorinated carbon is poly(carbon monofluoride).

45. The method of claim 43 wherein the alkali metal is lithium.

46. The method of claim 43 further comprising:
providing in the cathode an electrolyte-insoluble, rechargeable additive having an oxidation-reduction potential close to the operating potential of a (CFₓ)ₙ, cathode and a rate capability higher than that of (CFₓ)ₙ,
at least one of the additives being added in an amount effective to effect a performance improvement relative to an alkali metal-fluorinated carbon cell lacking the additive, the performance improvement being selected from the group consisting of improved storage capability at a storage temperature up to about 125° C., increased rate capability in a pulse test at −40° C. after storage at a temperature up to about 125° C., and reduced initial voltage delay under continuous discharge on constant load and pulse mode discharge.

47. The method of claim 46 wherein the electrolyte-insoluble additive comprises an inorganic material.

48. The method of claim 46 wherein the electrolyte-insoluble additive comprises an inorganic salt having a general formula AₓM_{y}O_{z}, where A is a metal from Group IA or IB of the Periodic Table of Elements, M is a transition metal or an element from Group IIIA, IVA, VA or VIA of the Periodic Table, and x, y, and z are integers chosen to balance the charge of the compound.

49. The method of claim 46 wherein the electrolyte-insoluble additive comprises a lithium salt.

50. The method of claim 46 wherein the electrolyte-insoluble additive comprises a transition metal oxide.

51. The method of claim 46 wherein the electrolyte-insoluble additive is selected from the group consisting of lithium titanium oxide, lithium vanadium oxide, lithium zirconium oxide, lithium niobium oxide, lithium tungsten oxide, lithium molybdenum oxide, lithium tantalum oxide, lithium manganese oxide, lithium cobalt oxide, lithium silicate, lithium sulfate, lithium borate, lithium phosphate, lithium aluminum oxide, and a mixture of any of the foregoing.

52. The method of claim 46 wherein the electrolyte-insoluble additive comprises an organic material.

53. The method of claim 52 wherein the organic material comprises polyaniline.

54. The method of claim 43 further comprising:
providing an electrolyte-soluble additive in the non-aqueous electrolyte, the additive comprising an oxygen and a nitrogen having an oxidation level higher than +2,
at least one of the additives being added in an amount effective to effect a performance improvement relative to an alkali metal-fluorinated carbon cell lacking the additive, the performance improvement being selected from the group consisting of improved storage capability at a storage temperature up to about 125° C., increased rate capability in a pulse test at −40° C. after storage at a temperature up to about 125° C., and reduced initial voltage delay under continuous discharge on constant load and pulse mode discharge.

55. The method of claim 54 wherein the electrolyte-soluble additive is selected from the group consisting of lithium nitrate and lithium nitrite.

56. A cathode for an electrochemical cell having a non-aqueous electrolyte, the cathode comprising:
a fluorinated carbon; and
at least one agent selected from the group consisting of (a) an electrolyte-insoluble, rechargeable additive in the cathode having an oxidation-reduction potential close to the operating potential of a (CFₓ)ₙ cathode and a rate capability higher than that of (CFₓ)ₙ, and (b) an additive that reacts in the cell to form a compound having the recited attributes of the electrolyte-insoluble, rechargeable additive.

57. The cathode of claim 56 wherein the fluorinated carbon is poly(carbon monofluoride).

58. The cathode of claim 56 wherein the electrolyte-insoluble additive comprises an inorganic material.

59. The cathode of claim 56 wherein the electrolyte-insoluble additive comprises an inorganic salt having a general formula AₓM_{y}O_{z}, where A is a metal from Group IA or IB of the Periodic Table of Elements, M is a transition metal or an element from Group IIIA, IVA, VA or VIA of the Periodic Table, and x, y, and z are integers chosen to balance the charge of the compound.

60. The cathode of claim 56 wherein the electrolyte-insoluble additive comprises a lithium salt.

61. The cathode of claim 56 wherein the electrolyte-insoluble additive comprises a transition metal oxide.

62. The cathode of claim 56 wherein the electrolyte-insoluble additive is selected from the group consisting of lithium titanium oxide, lithium vanadium oxide, lithium zirconium oxide, lithium niobium oxide, lithium tungsten oxide, lithium molybdenum oxide, lithium tantalum oxide, lithium manganese oxide, lithium cobalt oxide, lithium silicate, lithium sulfate, lithium borate, lithium phosphate, lithium aluminum oxide, and a mixture of any of the foregoing.

63. The cathode of claim 56 wherein the electrolyte-insoluble additive comprises an organic material.

64. The cathode of claim 63 wherein the organic material comprises polyaniline.
